(19) United States
(12) Patent Application Publication
(10) Pub. No.: US 2012/0051048 A1
(43) Pub. Date: Mar. 1, 2012

(54) Retrofit for Non-LED Lighting Fixture

(75) Inventors: Christiaan Coenraad Joubert Smit, Katy, TX (US); Jerry Douglas Leopold, Houston, TX (US)

(73) Assignee: U.S. LED, Ltd., Houston, TX (US)

(21) Appl. No.: 12/872,824

(22) Filed: Aug. 31, 2010

(51) Int. Cl. F21V 5/00; H01J 9/50; F21V 29/00; F21S 4/00; F21V 15/00

(52) U.S. Cl. 362/235; 362/249.02; 362/362; 362/373; 445/2

(57) ABSTRACT

A retrofit kit allows retrofitting a non-LED canopy or other light fixture for use with LED lamps. The retrofit procedure removes the original electrical components and replaces them with components for use with LED lamps. The same components may be used to manufacture a new LED light fixture that can be used in the same applications as non-LED light fixtures.

### TECHNICAL FIELD

The present invention relates to the field of lighting, and in particular to a retrofit of a non-LED lighting fixture or luminaire for use with LED lamps.

### BACKGROUND ART

Outdoor lighting is important to many commercial establishments. Once incandescent lamps were used for such lighting fixtures, but over the years, incandescent lamps have often been replaced with fluorescent, high-intensity discharge (HID), and mercury-vapor lamps. Recently, light emitting diode (LED) lamps have become available for such applications. LED lamps offer several advantages, including improved light quality, performance, life span, and costs, and their use and popularity have increased as high lumen LEDs have been developed. LED lighting offers the potential for significant reductions in power consumption per lumen.

One factor limiting the use of LED lighting systems has been the cost and inconvenience of removing conventional non-LED-based light fixtures or luminaires and installing new light fixtures that are designed and optimized for LED lamps. To defray this expense, attempts have been made to incorporate LED lamps in and on the surface of lamps designed to replace the conventional lamp electrically and mechanically in an otherwise unchanged socket.

This approach, while useful in some applications, cannot be used in many applications, where functional differences characteristic of LED lamps, such as heat sensitivity and light pattern differences between LED and conventional lamps, make LED lamps difficult to employ. Furthermore, power conversion units to convert line voltage to the voltage used by LED lamps are difficult to fit into conventional socket-style fixtures.

Therefore, there remains a need to provide improved and effective way of retrofitting LED lamps into conventional fixtures.

### SUMMARY OF INVENTION

In one embodiment, a retrofit kit for a light fixture is disclosed. The retrofit kit comprises a collection of retrofit components instructions for retrofitting the light fixture using the collection of retrofit components. The collection of retrofit components comprises a cover replacement unit; and a plurality of light emitting diode (LED) lamp units, configured to attach to the cover replacement unit.

In another embodiment, a light fixture is disclosed. The light fixture comprises a frame, configured for attachment to an overhead canopy, comprising a first portion, operatively positioned below the canopy and extending through an opening formed in the canopy; and a second portion, operatively positioned above the canopy and attached to the first portion; and a light emitting diode (LED) lamp unit, positioned at least partially exterior to the first portion.

In yet another embodiment, a method of retrofitting a light fixture is disclosed. The method comprises disconnecting the light fixture from an electrical main; opening the light fixture and removing a cover and a non-light emitting diode (LED) lamp; positioning a cover replacement unit in the light fixture, the cover replacement unit comprising: a frame configured to fit in the light fixture in place of the lens; and an LED lamp unit disposed with the frame, at least partially extending through an opening in a surface of the frame; closing the light fixture; removing a ballast from the light fixture; connecting the LED lamp unit electrically to the electrical main.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a side view of a typical canopy light fixture according to the prior art.

FIG. 2 is a side view illustrating the canopy light fixture of FIG. 1 retrofitted with LED lamps according to one embodiment.

FIG. 3 is a top view and a cross-sectional view illustrating a portion of a retrofit kit for use in the retrofit of the canopy light fixture of FIG. 1 according to one embodiment.

FIG. 4 is a side view illustrating the canopy light fixture of FIG. 1 retrofitted with LED lamps according to one embodiment.

FIG. 5 is a side view and a bottom view illustrating another canopy light fixture retrofitted with LED lamps according to one embodiment.

FIG. 6 is a side view and a bottom view illustrating yet a non-canopy light fixture retrofitted with LED lamps according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

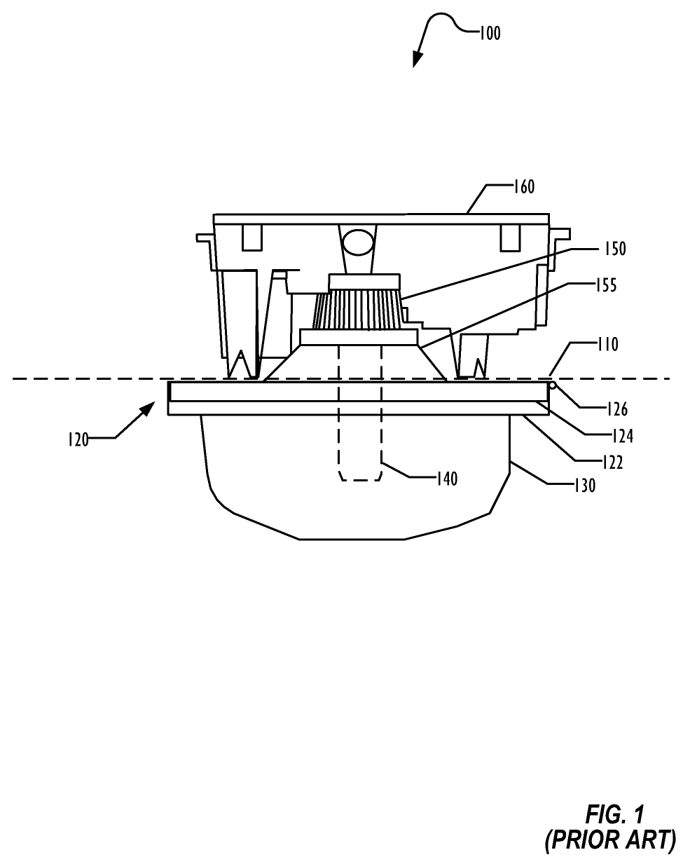

FIG. 1 illustrates a side view of a typical commercial light fixture 100 according to the prior art for which a retrofit kit is provided according to one embodiment. In this example, the light fixture 100 is an overhead canopy light fixture, such as are often found in automobile service stations and convenience stores. In this type of fixture, the fixture 100 is mounted on a relatively thin canopy 110, with a portion extending through an opening in the canopy 110.

In this example, a frame 120 comprises a fixed portion 124 and a moveable portion 122, attached by hinge 126 to fixed portion 124, to allow opening the fixture 100 and replacing the lamp 140. A cover 130 surrounds the lamp 140, and is held in place in an opening of moveable portion 124. Although not shown in FIG. 1 for clarity, other elements may be present, including a reflector to direct illumination from the lamp 140 in any desired direction.

The fixed portion 124 includes a socket portion 150 that extends through an opening in the canopy 110. The upper surface of the canopy 110 is typically open, allowing access to the socket portion 150. A ballast box 160 is attached to the socket portion 150 and holds electrical transformers and ballasts as needed for the operation of the light fixture 100 and is where the electrical mains (not shown in FIG. 1 for clarity) are connected to the light fixture 100. A collar 155 is designed to screw onto the socket 150 and to affix the frame 120 to the canopy 110. This type of canopy fixture is extremely popular, and one such fixture is sold under the name SCOTTSDALE® by LSI Industries, Inc. (SCOTTSDALE is a registered trademark of LSI Industries, Inc.)

In one embodiment, retrofitting an LED lamp kit into the fixture 100 involves opening the moveable portion of the frame 122, and disposing of the cover 130, the lamp 140, and other electrical components of the lighting fixture 100, including electrical components that are mounted in the ballast box 160.

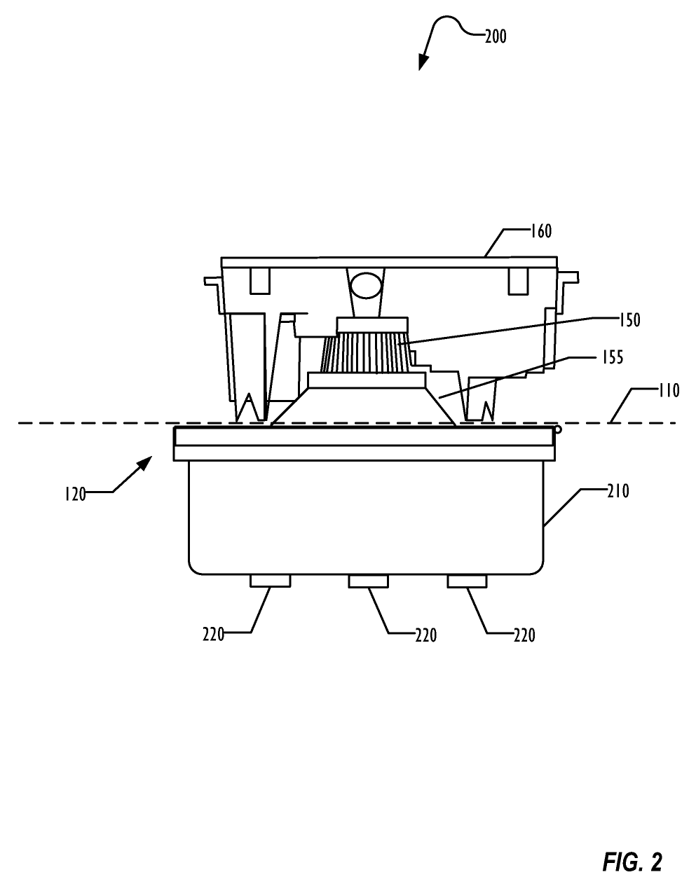

FIG. 2 is a side view 200 illustrating the retrofitted fixture of FIG. 1. A lamp box 210 is inserted into the moveable portion of the frame 122 to hold LED lamp units 220. As illustrated in FIG. 2, the original ballast box 160 remains mounted on top of the socket portion 150 in one embodiment. In other embodiments, the ballast box 160 may be replaced with a new box or part of the ballast box may be replaced. Electrical mains connect to the lamp units 220 through the ballast box 160. Each of the LED lamp units 220 comprises a plurality of LEDs, a cover to protect the LEDs and a frame for holding those components. The light of the LEDs is typically directed in a desired predetermined pattern by means of either optics integrated in the cover or optics mounted to individual LEDs, The LED lamp units are typically powered with a constant voltage or constant current power source. Although illustrated in FIG. 2 with three such LED lamp units 220, any number of LED lamp units 220 may be used, typically ranging from 2-4, as needed for the lighting application and depending upon the size of the frame 120. One example of such a lamp unit is the QUBE™ modular lighting system manufactured by U.S. LED, Ltd. (QUBE is a trademark of U.S. LED, Ltd.) the shape of the configuration of the lamp box 210 and lamp units 220 are illustrative and by way of example only.

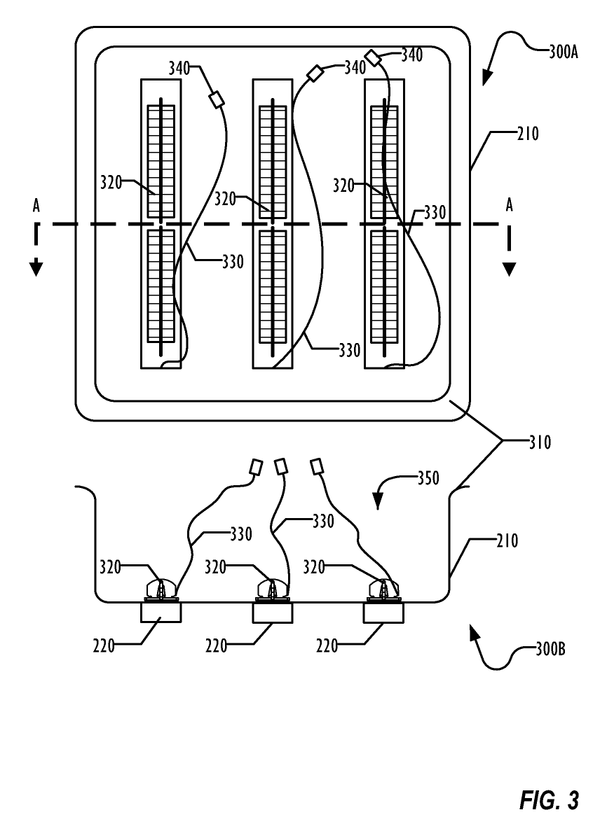

FIG. 3 illustrates two views of the lamp box 210 for retrofitting into the fixture 100. In top view 300A, the lamp box 210 is shown together with three example lamp units 220 and connecting wires 330. A flange 310 surrounds the upper opening of the lamp box 210, to provide support when inserted into frame moveable portion 122.

As illustrated in this view, the lamp units 220 in one embodiment are attached to heat sinks 320 for transfer of heat from the lamp units 220. The heat sink unit 320 is mounted to a plate on the frame of the lamp unit 220. Heat sinks may be obtained from numerous manufacturers. In one embodiment, the heat sink 320 is an ECB-00399-01-GP manufactured by Cooler Master, Inc. that includes multiple vanes and fluid-filled heat pipes to increase the heat transfer. Other types of heat sinks may be used, depending on the thermal resistance of the LEDs mounted in the lamp units 220 and is expected environmental conditions.

The lamp box 210 provides sufficient air volume to allow the dissipation of heat from the lamp units 220. In addition, the lamp box 210 extends below the canopy 110 less than the original cover 130, and the retrofitted light fixture 100 retains the original clearance at the bottom of the lighting fixture 100. Preferably, the additional vertical extension of the lamp units 220 does not exceed the vertical extension of the original cover 130. Vehicles driving beneath the canopy should not endanger the retrofitted lighting fixtures 100 if the vehicle would clear the original fixture 100.

View 300B is a cross-section of the lamp box 210 at line A-A, illustrating an embodiment in which the LED lamps are positioned and exposed below the bottom surface of the lamp box 210, while the heat sinks extend above the surface of the lamp box 210 in the cavity 350.

Each of the lamp units 220 may contain a plurality of LEDs. In one embodiment, 28 LEDs are used and oriented to provide a lighting pattern similar or better than the lighting pattern of the original lamp 140. The lamp units 220 are preferably manufactured to provide IP65 level or better protection as defined in international standard IEC 60529, preventing dust and low-pressure water streams from entering the LED lamp units 220. In embodiments where the light fixture is less exposed to rain and other difficult environmental conditions, a lower level of protection may be used as desired.

To reduce the heat load in the lamp box 210 further, other electrical components may be placed above the canopy 110 in the ballast box 160. Wires 330 and connectors 340 are used to connect the lamp units 220 to the electrical mains and other electrical components above the canopy 110. The connectors 340 may be of any desired type, including twist-on wire connectors. In one embodiment, a single connector 340 joins all of the wires 330, allowing a single electrical connection for the retrofit fixture 100 from the lamp units 220. In other embodiments, the retrofit kit is provided with the connectors detached from the wires, to allow threading the wires 330 through an existing opening in an upper surface of the socket 150, after which the connectors may be applied to connect the wires to the electrical components above the canopy 110.

In one embodiment, the lamp box 210 may be welded, made of sheet metal, or die cast. The lamp box 210 may be made of aluminum or other suitable material. In other embodiments, the lamp box 210 may be formed of any desired material suitable for the heat load of the lamp units 220 and other environmental conditions. Unlike the original lens, the lamp box 210 may be opaque, since the light is emitted exterior to the lamp box 210.

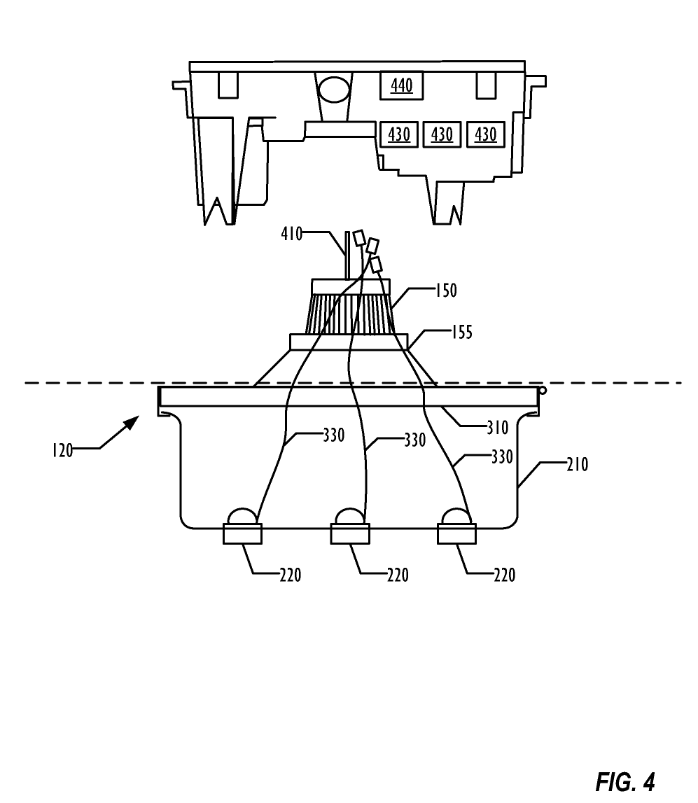

FIG. 4 illustrates a cross-sectional view of one embodiment of a retrofitted light fixture 100. The wires 330 are brought through an opening in a top surface of the socket section 150 and connected to power supply units 430 in the ballast box 160. The ballast box 160 may be mounted on a bolt or other fastener 410 that extends from the socket section 150. The ballast box 160 is secured to bolt 410 with a wing nut or other desired type of fastener.

In one embodiment, the power supply units 430 are power converters that convert AC mains power into the constant current or constant voltage DC voltage used by LED units 220. In another embodiment, in which the LED lamps can run directly off of main AC voltage, the power supply units 430 may be omitted. In some lighting fixtures, the external mains provide AC voltage at 120, 208, 240, or 277V. In other fixtures, the electrical mains may provide AC voltage at 480V. In one embodiment, the power supply units 430 can connect to up to 277VAC. For 480VAC mains, a step-down transformer 440 may be needed and included in ballast box 160.

A retrofit kit for the light fixture 100 according to one embodiment includes a collection of retrofit components, including the lamp box 210, the lamp units 220, wires 330, and connectors 340, the power supplies 430, and optionally one or more transformers 440. Additional screws and nuts for connecting the various pieces may also be included, as well as sealant, gaskets, and instructions for doing the retrofit. In some embodiments, the lamp box 210 may be provided with preinstalled lamp units 220; in other embodiments, the installer will need to assemble the lamp units 220 with the lamp box 210 prior to or during installation.

A person performing the retrofit typically will begin by disconnecting the electrical mains to the light fixture 100. The retrofitter may then open the light fixture 100 by unlatching the door portion 122 and removing cover 130, lamp 140, and the lamp socket mounted in the socket section 150. The light fixture typically remains attached to the canopy during the retrofit operation, but may be removed for the retrofit operation if desired.

The retrofit kit is then installed by inserting the lamp box 210 and the lamps 220 into the frame section 124, feeding the connector wires 330 through the socket section 150, then closing and re-latching the moveable frame portion 122 to the fixed portion 124. If the light fixture was removed from the canopy earlier, the light fixture 100 may then be raised back into place, extending the socket section 150 through the canopy 110 and attaching the collar 155 to affix the frame 120 to the canopy 110. The wires 330 may then be connected to the power supplies 430 with the connectors 340 and the ballast box 160 re-bolted to bolt 410. After installation, the electrical mains may be reconnected, providing power to the lighting fixture 100. The order of actions described above is illustrative and by way of example only.

In one embodiment, the power supply units 430 may be installed in the original ballast box 160 after removing its original electrical components, using a mounting plate that fits into the ballast box 160. A transient voltage suppressor (not shown) may also be included to protect the power supply units 430 from voltage spikes, if desired.

In one embodiment, the power supply units 430 may be placed in the lamp box 210. In such an embodiment, the power supply units 430 may need to be placed in a pocket formed in the lamp box 210, to isolate to the heat produced by the power supply units 430 from the heat of the lamp units 220. In that embodiment, the empty ballast box 160 may be used for holding electrical main connections, or may be replaced by another component to hold the below-canopy components in place.

In one embodiment, the retrofit kits may include temperature sensors placed in the lamp box 210 and circuitry to reduce the current to the lamp units 220 if the temperature sensors indicate a temperature above a predetermined threshold.

In one embodiment, the lamp box 210 has sufficient volume to provide sufficient air cooling of the lamp units. In one embodiment, the lamp box has a volume of at least 5735 cubic centimeters (350 cubic inches). Lamp boxes of various sizes may be used depending upon the cooling needs of the lamp units 220 and expected environmental conditions. As illustrated in FIG. 4, the lamp units 220 are typically distributed evenly across a bottom surface of the lamp box 210, but may be positioned anywhere on the exterior of lamp box 210 in any desired arrangement.

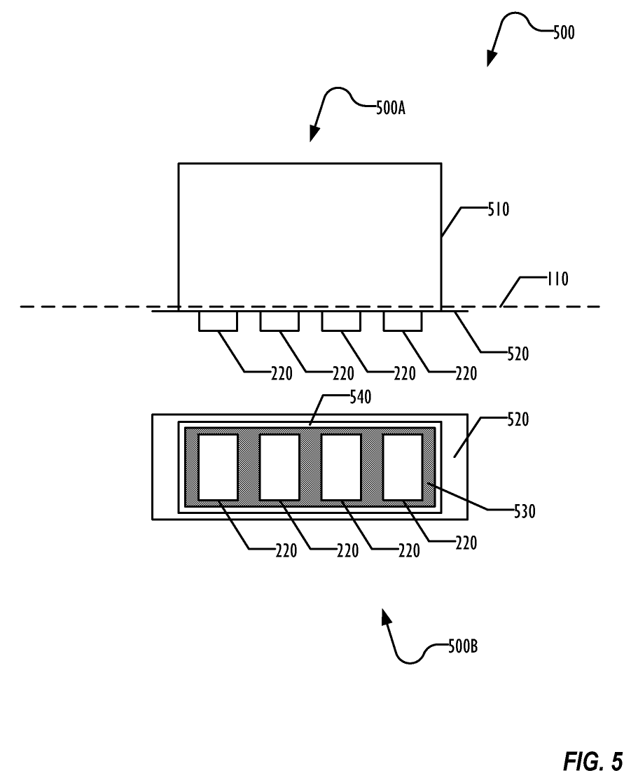

Embodiments are not limited to canopy-style lamps such as illustrated in FIG. 1-4. FIG. 5 illustrates a retrofit of a canopy lighting fixture 500 in which the light fixture 500 is recessed into a space above the canopy 110 as illustrated in view 500A, with a flange 520 extending beyond an opening in the canopy 110, while box portion 510 extends through and above the canopy 110. A retrofit kit for such a light fixture according to one embodiment includes a panel or plate 530 that replaces a door assembly 540 of the original fixture 500. The panel 530 may have any desired number of lamp units 220 attached to it, typically 2-4 lamp units 220. In this embodiment, the power supply units 430 may be mounted inside the box portion 510 above the canopy, omitting ballast box 160. As with the previous embodiment, a retrofitter would open the door assembly 540 of the light fixture 500 and remove it and all electrical components from the fixture 500, except for electrical leads used for connecting the fixture to the electrical mains. The plate 530 may then be placed into the opening previously occupied by the now-removed door assembly 540, the power supply units 430 affixed to the inside of the box 510 and connected to the wires 330 from the lamp units 220, then connected to the lead wires and thence to the electrical mains.

As illustrated in bottom view 500B, the lamp units 220 are typically distributed evenly across the plate 530, but may be positioned in plate 530 in any desired arrangement.

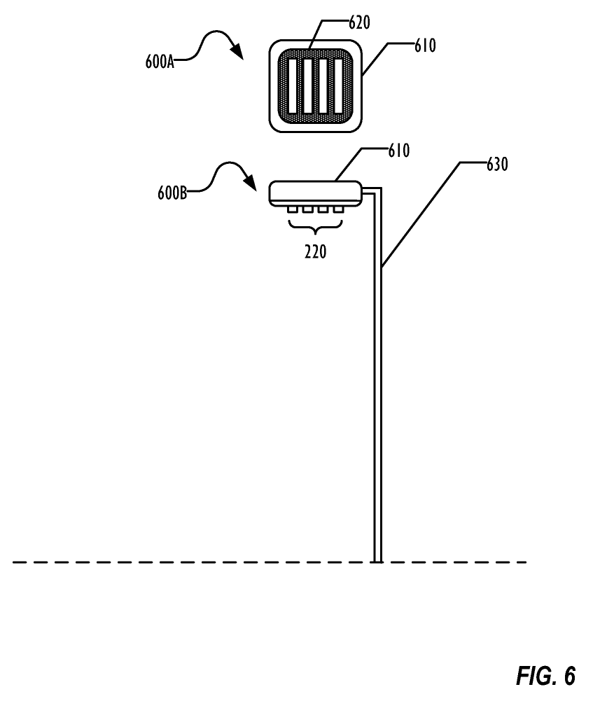

The present invention is not limited to retrofits of canopy lighting fixtures. FIG. 6 is a bottom view 600A and a side view 600B, illustrating a retrofitted lighting fixture such as found in the open-air parking lots. The lighting fixture is mounted to a pole 630 at a desired height. As with the recessed light fixture of FIG. 5, a plate 620 replaces the cover of the original fixture in one embodiment, and a desired number of lamp units 220 are mounted to the plate 620, while power supply units 430 are affixed inside the structural body 610 of the light fixture. In other embodiments, the structural body 610 has sufficient volume to allow the LED lamp units 220 to be mounted inside the original cover, typically a glass panel. A similar retrofit procedure may be used as those described above.

Although the description above has been given in terms of retrofitting an existing non-LED light fixture, one of skill in the art will recognize that a manufacturer of such light fixtures could use the components and techniques described above to manufacture an LED light fixture for canopies, etc. In such an embodiment, of course, the installer would not need to replace any of the non-LED components, but would simply assemble the components as necessary and install the light fixture.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A retrofit kit for a light fixture, comprising:
a collection of retrofit components, comprising:
a cover replacement unit;
a plurality of light emitting diode (LED) lamp units, configured to attach to the cover replacement unit; and
instructions for retrofitting the light fixture using the collection of retrofit components.

2. The retrofit kit of claim 1, wherein the collection of retrofit components further comprises:
a plurality of heat sinks, each affixed to one of the plurality of LED lamp units.

3. The retrofit kit of claim 1, wherein the cover replacement unit is opaque.

4. The retrofit kit of claim 1, wherein the plurality of LED lamp units is preassembled with the cover replacement unit.

5. The retrofit kit of claim 1, wherein the collection of retrofit components further comprises:
a plurality of power supply units, configured to supply a current and voltage usable by the plurality of LED lamp units; and
a plurality of lead wires, each of which connected to one of the plurality of LED lamp units, configured for electrical connection with one of the plurality of power supply units.

6. The retrofit kit of claim 1,
wherein the light fixture is a canopy light fixture, comprising:
a first portion, operatively positioned below the canopy, comprising:
a lens, extending below the canopy a first distance; and
a lamp;
a second portion, operatively positioned above the canopy and affixed to the first portion, operatively extending through the canopy; and
a third portion, operatively attached to the second portion to hold the first portion and the second portion with the canopy.

7. The retrofit kit of claim 6, wherein the lens replacement unit, when retrofitted into the first portion of the light fixture, extends below the canopy less than the first distance.

8. The retrofit kit of claim 6, further comprising:
a plurality of power supply units, configured to supply a current and voltage usable by the plurality of LED lamp units,
wherein the plurality of power supply units are retrofitted into the second portion.

9. The retrofit kit of claim 6, further comprising:
a plurality of power supply units, configured to supply a current and voltage usable by the plurality of LED lamp units,
wherein the lens replacement unit defines a first volume and a second volume, and
wherein the LED lamp units emit heat into the first volume and the power supply units are positioned in the second volume.

10. The retrofit kit of claim 1, further comprising:
a plurality of power supply units, configured to supply a current and voltage usable by the plurality of LED lamp units.

11. The retrofit kit of claim 10, wherein the collection of retrofit components further comprises:
a plurality of lead wires, each of which connected to one of the plurality of LED lamp units, configured for electrical connection with one of the plurality of power supply units through the socket portion of the light fixture.

12. A light fixture, comprising:
a frame, configured for attachment to an overhead canopy, comprising:
a first portion, operatively positioned below the canopy and extending through an opening formed in the canopy; and
a second portion, operatively positioned above the canopy and attached to the first portion; and
a light emitting diode (LED) lamp unit, positioned at least partially exterior to the first portion.

13. The light fixture of claim 12,
a power supply unit, positioned in the second portion above the canopy and electrically connected to the LED lamp unit, configured to supply a current and voltage usable by the LED lamp unit.

14. The light fixture of claim 12, further comprising:
a heat sink, attached to a surface of the LED lamp unit, positioned interior to the frame.

15. A method of retrofitting a light fixture, the method comprising:
disconnecting the light fixture from an electrical main;
opening the light fixture and removing a cover and a non-light emitting diode (LED) lamp;
positioning a cover replacement unit in the light fixture, the cover replacement unit comprising:
a frame configured to fit in the light fixture in place of the lens; and
an LED lamp unit disposed with the frame, at least partially extending through an opening in a surface of the frame;
closing the light fixture;
removing a ballast from the light fixture;
connecting the LED lamp unit electrically to the electrical main.

16. The method of claim 15, further comprising:
assembling the cover replacement unit, comprising:
disposing the LED lamp unit with the opening in the surface of the frame.

17. The method of claim 15, wherein the cover replacement unit further comprises:
a heat sink affixed to the LED lamp unit interior to a volume defined by the frame.

18. The method of claim 15, further comprising:
wherein the light fixture is a canopy light fixture, and
disposing a power supply unit with the light fixture comprising:
disposing the power supply unit above the canopy; and
electrically connecting the power supply unit to the LED lamp unit through an opening in the canopy.

19. The method of claim 15,
wherein the power supply unit converts AC main power into a current and voltage usable by the LED lamp unit.

20. The method of claim 15,
wherein the light fixture comprises a socket portion that extends through an opening in a canopy,
wherein the act of connecting the LED lamp unit to the electrical main comprises:
disposing a power supply unit with the light fixture;
wiring the LED lamp unit to the power supply unit through the socket portion; and
wiring the power supply unit to the electrical main.
